(19) United States
(12) Patent Application Publication
(10) Pub. No.: US 2024/0401882 A1
(43) Pub. Date: Dec. 5, 2024

(54) A METHOD FOR EVENING OUT THE FEEDING OF REACTION GAS WHEN FEEDING REACTION GAS INTO A SUSPENSION SMELTING FURNACE AND A BURNER

(71) Applicant: METSO METALS OY, Espoo (FI)

(72) Inventors: Peter BJÖRKLUND, Espoo (FI); Kaj EKLUND, Espoo (FI)

(21) Appl. No.: 18/687,900

(22) PCT Filed: Sep. 3, 2021
(86) PCT No.: PCT/FI2021/050593

§ 371 Date: Feb. 29, 2024

(51) Int. Cl. F27B 15/10; F27D 3/16

(52) U.S. Cl. CPC F27B 15/10; F27D 3/16; F27D 2003/166

(57) ABSTRACT

A method for evening out the feeding of reaction gas when feeding solid material and reaction gas into a reaction shaft of a suspension smelting furnace by means of a burner. The method includes feeding solid material into the reaction shaft by means of a feeder pipe of the burner, and feeding reaction gas into the reaction shaft by means of a gas supply device of the burner. The method includes providing a gas deflection member in a reaction gas chamber of the burner. Presented is also a burner.

### FIELD

The invention relates to a method for evening out the feeding of reaction gas when feeding solid material and reaction gas into a reaction shaft of a suspension smelting furnace by means of a burner as defined in the preamble of independent claim 1.

The invention also relates to a burner for feeding solid material and reaction gas into a reaction shaft of a suspension smelting furnace as defined in the preamble of independent claim 22.

Publication WO 2009/030808 presents a concentrate burner for feeding a solid concentrate mixture and reaction gas into the reaction shaft of a flash smelting furnace.

### Objective

The object of the invention is to provide a method for evening out the feeding of reaction gas when feeding solid material and reaction gas into a reaction shaft of a suspension smelting furnace by means of a burner and to provide a burner with an improved ability for evening out the feeding of reaction gas when feeding solid material and reaction gas into a reaction shaft of a suspension smelting furnace by means of the burner.

### Short Description

The method of the invention is characterized by the definitions of independent claim 1.

Preferred embodiments of the method are defined in the dependent claims 2 to 21.

The burner of the invention is correspondingly characterized by the definitions of independent claim 22.

Preferred embodiments of the burner are defined in the dependent claims 23 to 42.

### LIST OF FIGURES

In the following the invention will described in more detail by referring to the figures, of which

FIG. 1 shows a suspension smelting furnace,

FIG. 2 shows in partly transparent view a first embodiment of the burner,

FIG. 3 shows in section view a second embodiment of the burner,

FIG. 4 shows in partly transparent view a third embodiment of the burner,

FIG. 5 shows in section view a fourth embodiment of the burner,

FIG. 6 shows in partly transparent view a fifth embodiment of the burner,

FIG. 7 shows in partly transparent view a sixth embodiment of the burner,

FIG. 8 shows in partly transparent view an seventh embodiment of the burner

FIG. 9 shows a variant of the gas deflection member that can be used in some embodiments of the burner,

FIG. 10 shows in partly transparent view an eight embodiment of the burner,

FIG. 11 shows in partly transparent view a ninth embodiment of the burner,

FIG. 12 shows in partly transparent view a tenth embodiment of the burner,

FIG. 13 shows in partly transparent view an eleventh embodiment of the burner,

FIG. 14 shows in partly transparent view a twelfth embodiment of the burner, and

FIG. 15 shows in partly transparent view a thirteenth embodiment of the burner.

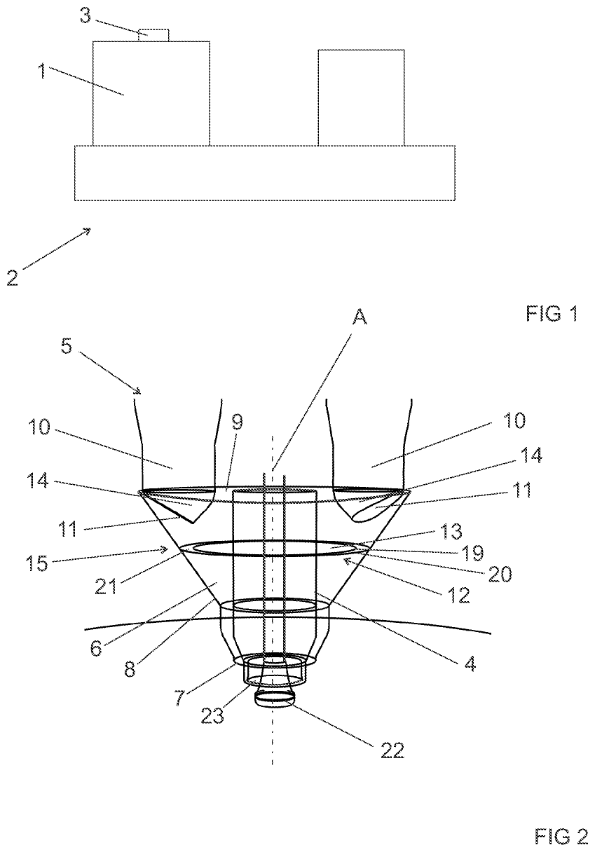

### DETAILED DESCRIPTION OF THE INVENTION

First the method for evening out the feeding of reaction gas when feeding solid material and reaction gas into a reaction shaft 1 of a suspension smelting furnace 2 by means of a burner 3 and some embodiments and variants of the method will be presented in greater detail.

The reaction gas can for example comprise air, oxygen-enriched air, and/or oxygen.

The solid material can for example comprise sulphidic concentrate, flux, slag former, and/or electronic scrap.

The suspension smelting furnace 2 can be a flash smelting or a flash converting furnace.

The burner 3 can be a concentrate or a matte burner.

The method comprises feeding solid material into the reaction shaft 1 of the suspension smelting furnace 2 by means of a feeder pipe 4 of the burner 3. The suspension smelting furnace 2 comprises additionally a settler (not marked with a reference numeral) configured to receive material from the reaction shaft 1 and an uptake (no marked with a reference numeral) for leading process gases from the settler.

The method comprises feeding reaction gas into the reaction shaft 1 of the suspension smelting furnace 2 by means of a gas supply device 5 of the burner 3, wherein the gas supply device 5 comprises a reaction gas chamber 6, which surrounds, preferably concentrically surrounds, the feeder pipe 4, wherein the gas supply device 5 opens to the reaction shaft 1 of the suspension smelting furnace 2 through an annular opening 7, wherein the reaction gas chamber 6 being at least partly laterally outwardly limited by an inner wall section 8 tapering, preferably conically tapering, towards the annular opening 7, and being partly limited by a top structure 9.

The method comprises feeding reaction gas into the reaction gas chamber 6 through a feed opening 11 of at least one inlet channel 10 of the gas supply device 5.

The method comprises providing a gas deflection member 12 in the reaction gas chamber 6, wherein the gas deflection member 12 limiting at least one through opening 13 leading through the gas deflection member 12.

The gas deflection member 12 is preferably, but not necessarily, stationary such as nonrotatable provided with respect to the reaction gas chamber 6.

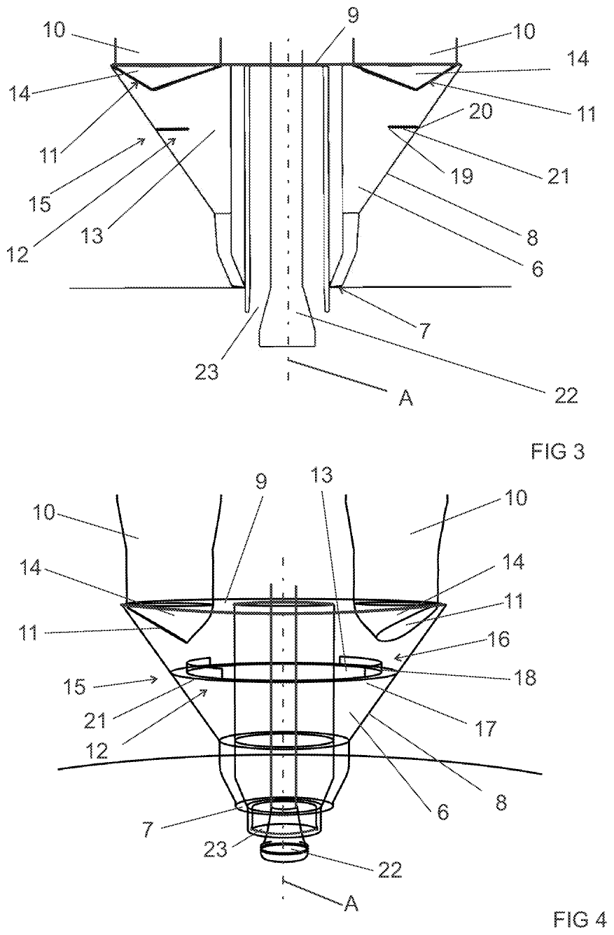

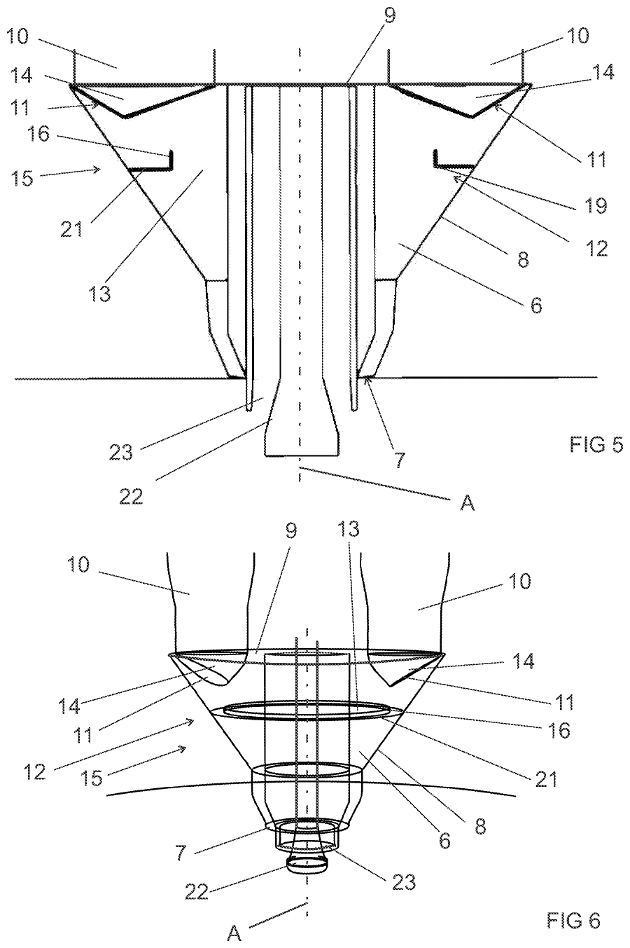

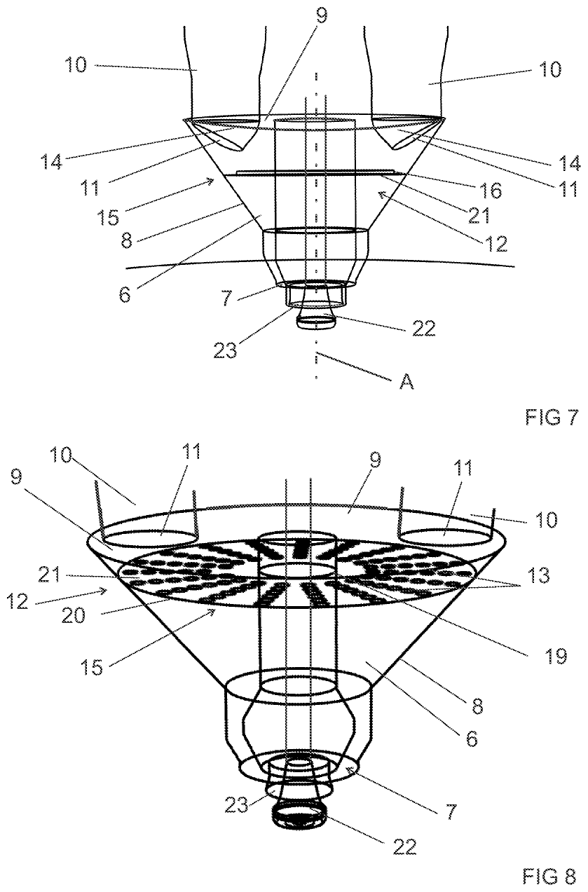

The method comprises directing reaction gas into the reaction gas chamber 6 from said feed opening 11 of said at least one inlet channel 10 of the gas supply device 5 towards the inner wall section 8 tapering towards the annular opening 7 and/or towards the gas deflection member 12. The method comprises preferably, but not necessarily, as in the embodiments illustrated in FIGS. 2 to 8, and 11, directing reaction gas into the reaction gas chamber 6 between the top structure 9 and the gas deflection member 12 from said feed opening 11 of said at least one inlet channel 10 of the gas supply device 5 towards the inner wall section 8 tapering towards the annular opening 7 and/or towards the gas deflection member 12. Towards the gas deflection member 12 means in this context that reaction gas is not directed solely towards one through opening 13 leading through the gas deflection member 12, but at least partly towards material forming the gas deflection member 12 so as to at least partly avoid that reaction gas flows directly out of the reaction gas chamber 6 from the annular opening 7. The purpose of the gas deflection member 12 is to divert the direction of the reaction gas and so to even out the flow of reaction gas within the reaction gas chamber 6 so that the flow of reaction gas from the annular opening 7 into the reaction shaft 1 of the suspension smelting furnace 2 will be more evenly distributed so as to promote reactions between reaction gas and solid material in the reaction shaft 1 of the suspension smelting furnace 2 which leads to a higher metal recovery from the solid material that is fed into the reaction shaft 1 of the suspension smelting furnace 2 by means of the burner 3. The gas deflection member 12 will also even out possible differences in flow velocity of the reaction gas flowing from the annular opening 7 at different locations of the annular opening 7.

The method can in some embodiments and variants of the method, such as in the embodiments illustrated in FIGS. 2 to 7 and 11, include arranging said at least one inlet channel 10 of the gas supply device 5 to penetrate into the reaction gas chamber 6 so that said at least one inlet channel 10 have a channel section 14 inside the reaction gas chamber 6 and so that said feed opening 11 of said at least one inlet channel 10 is inside the reaction gas chamber 6. Such embodiments and variants of the method includes preferably, but not necessarily, arranging said at least one inlet channel 10 of the gas supply device 5 to pass through the top structure 9 of the reaction gas chamber 6, as illustrated in FIGS. 2 to 7 and 11. Such embodiments and variants of the method includes preferably, but not necessarily, arranging said channel section 14 bent and/or angled away from the central axis A of the burner 3 to direct reaction gas from the feed opening 11 towards the inner wall section 8 tapering towards the annular opening 7 between the top structure 9 and the gas deflection member 12, as illustrated in FIGS. 2 to 7 and 11, so as to promote even distribution of reaction gas in the reaction gas chamber 6 and so as to even out possible differences in flow velocity of the reaction gas prior reaction gas exiting the reaction gas chamber 6 through the annular opening 7 and enters the reaction shaft 1 of the suspension smelting furnace.

The method can in some embodiments and variants of the method, as illustrated in FIGS. 2 to 7 and 11, include arranging a plurality of inlet channels 10 of the gas supply device 5 to pass through the top structure 9 in a configuration symmetrical to a central axis A of the burner 3 so that each of said plurality of inlet channels 10 having a channel section 14 inside the reaction gas chamber 6, arranging each channel section 14 bent and/or angled away from the central axis A of the burner 3 to direct reaction gas from the feed opening 11 towards the inner wall section 8 tapering towards the annular opening 7 between the top structure 9 and the gas deflection member 12, and arranging the feed openings 11 of the inlet channels 10 in a configuration symmetrical to a central axis A of the burner 3, so as to promote distribution of reaction gas in the reaction gas chamber 6 and so as to even out possible differences in flow velocity of the reaction gas prior reaction gas exiting the reaction gas chamber 6 through the annular opening 7 and enters the reaction shaft 1 of the suspension smelting furnace 2.

It is also possible to arrange the feed opening 11 of said at least one inlet channel 10 at the top structure 9, as illustrated in FIGS. 8 and 10.

It is also possible to arrange the feed opening 11 of said at least one inlet channel 10 at the inner wall section 8 partly limiting the reaction gas chamber 6, as illustrated in FIGS. 12 to 15.

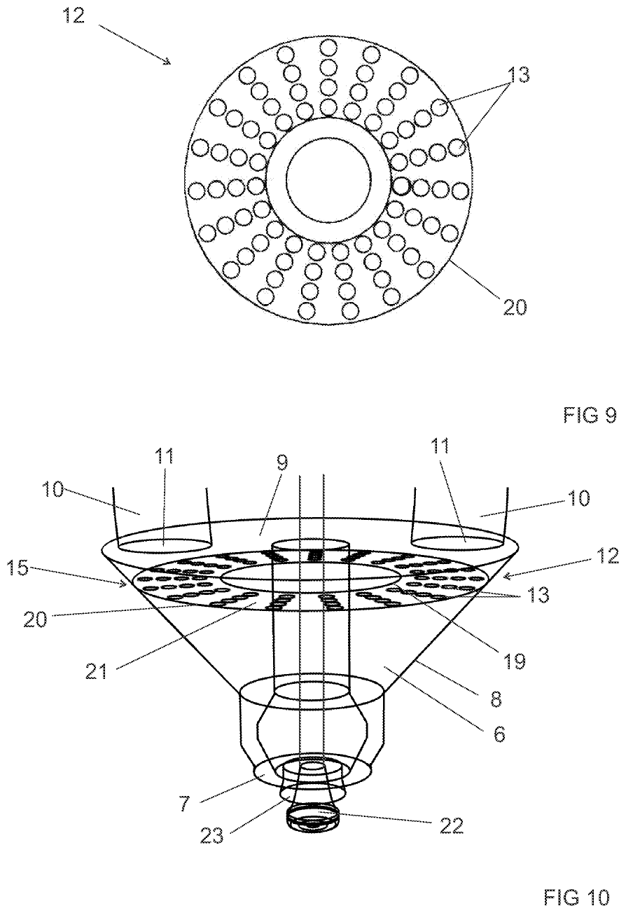

The gas deflection member 12 that is provided can in some embodiments and variants of the method, as illustrated in FIGS. 2 to 15, comprise a surrounding structure 15 that surrounds the feeder pipe 4.

If the method comprises providing a gas deflection member 12 comprising a surrounding structure 15, the surrounding structure 15 of the gas deflection member 12 that is provided can, as illustrated in FIG. 12, comprise a tubular member provided with a plurality of through openings 13 leading through the wall of the gas deflection member 12 in the form of a tubular member. The tubular member is preferably, but not necessarily, dimensioned and designed so that the annular opening 7 is visible from the top structure 9 so that for example a camera can be provided at the top structure 9 so as to enable monitoring of the smelting process in the reaction shaft 1 of the suspension smelting furnace by means of a camera can be provided at the top structure 9 through the annular opening 7.

If the method comprises providing a gas deflection member 12 comprising a surrounding structure 15, the method comprises preferably, but not necessarily, providing the surrounding structure 15 gas deflection member 12 at the inner wall section 8 tapering towards the annular opening 7 as in the embodiments illustrated in FIGS. 2 to 8, 10, 11, and 13 to 15.

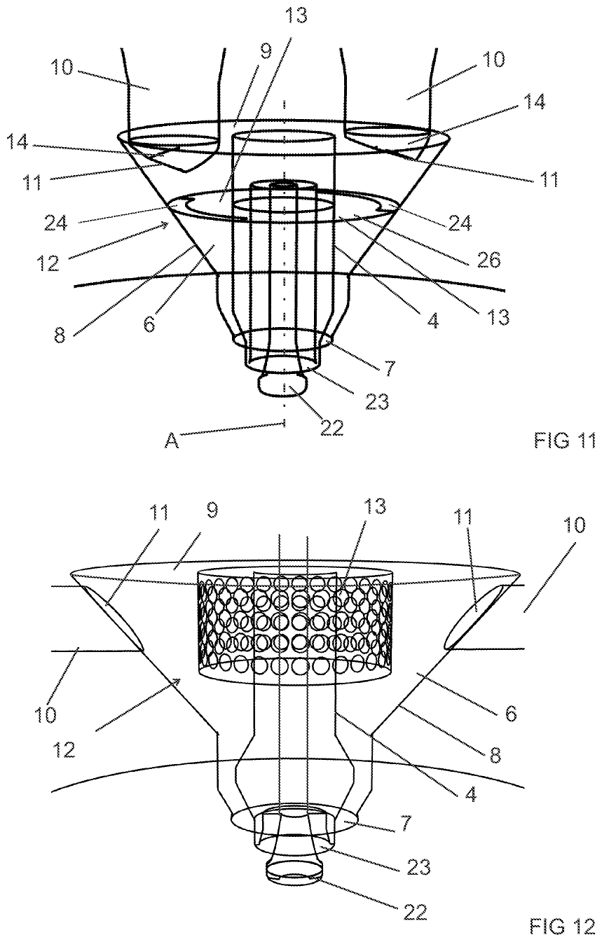

If the gas deflection member 12 that is provided comprise a surrounding structure 15 that surrounds the feeder pipe 4, the surrounding structure 15 of the gas deflection member 12 can in some embodiments and variants of the method, as illustrated in FIGS. 2 to 8, 10, 11 and 13 to 15, comprise an annular disc 21 comprising an inner circumference 19 and an outer circumference 20. Such embodiments and variants of the method comprises preferably, but not necessarily, attaching the outer circumference 20 of the annular disc to the inner wall section 8 tapering towards the annular opening 7 as illustrated in FIGS. 2 to 8, 10, 11 and 13 to 15. The annular disc 21 of the surrounding structure 15 of the gas deflection member 12 that is provided can have at least one disc discontinuity point 26 that forms a through opening 13 leading through the gas deflection member 12. The annular disc 21 of the surrounding structure 15 of the gas deflection member 12 that is provided can be formed of a plurality of arc sections 24 spaced from one another in the circumferential direction of the surrounding structure 15 so that a through opening 13 leading through the gas deflection member 12 is formed between two arc sections 24 spaced from one another in the circumferential direction of the surrounding structure 15, as in the ninth embodiment illustrated in FIG. 11. Such arc sections 24 are preferably, but not necessarily, symmetrically provided so as to at least partly promote for a symmetrical flow of reaction gas from the annular opening 7. The annular disc 21 has preferably, but not necessarily, an essentially flat and planar configuration.

If the gas deflection member 12 that is provided comprise a surrounding structure 15 that comprises an annular disc 21, the gas deflection member 12 comprises preferably, but not necessarily, as in the embodiments illustrated in FIGS. 2 to 6, 11, and 13 to 15, one through opening 13 that is formed in the form of a central through opening that is limited by the inner circumference 19 of the annular disc 21 of the surrounding structure 15 of the gas deflection member 12 that is provided. The central through opening is preferably, but not necessarily, dimensioned and designed so that the annular opening 7 is visible from the top structure 9 so that for example a camera can be provided at the top structure 9 so as to enable monitoring of the smelting process in the reaction shaft 1 of the suspension smelting furnace by means of a camera can be provided at the top structure 9 through the annular opening 7.

If the gas deflection member 12 that is provided comprise a surrounding structure 15 that comprises an annular disc 21, the method comprises preferably, but not necessarily, providing the annular disc 21 of the surrounding structure 15 of the gas deflection member 12 that is provided with a rim member 16, as illustrated in FIGS. 4 to 7. The purpose of the rim member 16 is to deflect the flow of reaction gas in the reaction gas chamber 6 so as to promote even distribution of reaction gas in the reaction gas chamber 6 and so as to even out possible differences in flow velocity of the reaction gas prior reaction gas exiting the reaction gas chamber 6 through the annular opening 7 and enters the reaction shaft 1 of the suspension smelting furnace. The method can comprise providing the rim member 16 to have at least one rim discontinuity point 17 as illustrated in FIG. 4. The method can comprise providing the rim member 16 to comprise a plurality of rim sections 18 spaced from one another in the circumferential direction of the annular 30 disc 21 as illustrated in FIG. 4. Such rim sections 18 are preferably, but not necessarily, as illustrated in FIG. 4, symmetrically provided so as to at least partly promote for a symmetrical flow of reaction gas from the annular opening 7 and so as to even out possible differences in flow velocity of the reaction gas prior reaction gas exiting the reaction gas chamber 6 through the annular opening 7 so as to promote reactions between reaction gas and solid material in the reaction shaft 1 of the suspension smelting furnace 2 which leads to a higher metal recovery from solid material that is fed into the reaction shaft 1 of the suspension smelting furnace 2 by means of the burner 3.

The method can comprise providing the rim member 16 at the inner circumference 19 of the annular disc 21 as illustrated in figured 4 to 7.

If the gas deflection member 12 that is provided comprise a surrounding structure 15 that comprises an annular disc 21, the method comprises preferably, but not necessarily, as illustrated in FIG. 4, providing the burner 3 with two inlet channels 10 each having one feed opening 11 so that the feed openings 11 are provided diametrically with respect to the feeder pipe 4 on opposite sides of the feeder pipe 4 and providing a rim member 16 comprising two rim sections 18 diametrically at the annular disc 21 so that one rim section 18 is provided axially below one of the inlet channels 10 and so that the other rim section 18 is provided axially below the other of the inlet channels 10 so that reaction gas fed from one of the feed openings 11 of the inlet channels 10 will in the reaction gas chamber 6 be re-directed by one of the rim sections 18 so as to promote distribution of reaction gas in the reaction gas chamber 6 and so as to even out possible differences in flow velocity of the reaction gas prior reaction gas exiting the reaction gas chamber 6 through the annular opening 7 and entering the reaction shaft 1 of the suspension smelting furnace 2.

If the gas deflection member 12 that is provided comprise a surrounding structure 15 that comprises an annular disc 21, the method can comprise, as illustrated in FIG. 8, attaching the inner circumference 19 of the annular disc 21 to the feeder pipe 4 for feeding solid material into the reaction shaft 1 of the suspension smelting furnace 2, and providing the annular disc 21 with a plurality of through openings 13 leading through the annular disc 21 of the gas deflection member 12.

If the gas deflection member 12 that is provided comprise a surrounding structure 15 that comprises an annular disc 21, the method can comprise, as illustrated in FIG. 10, providing the annular disc 21 with a plurality of through openings 13 leading through the annular disc 21 of the gas deflection member 12.

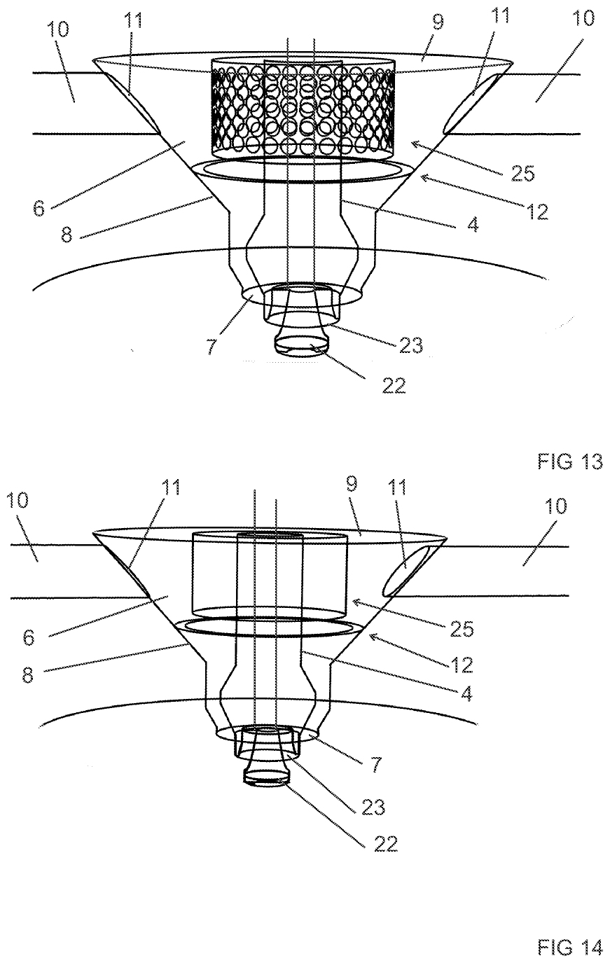

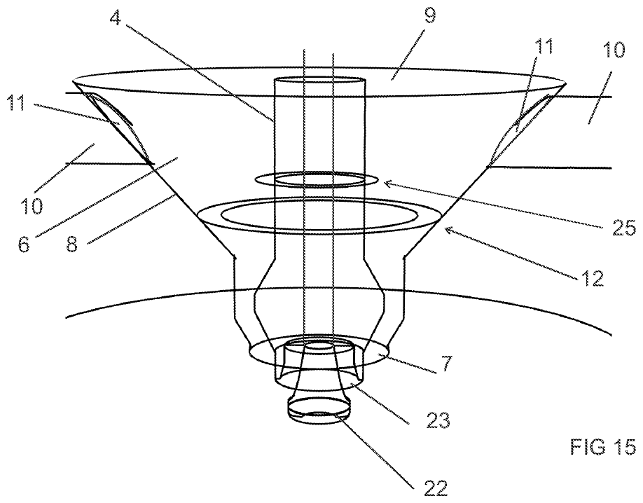

The method can include providing the burner 3 in addition to the gas deflection member 12 with an additional gas deflection member 25 in the reaction gas chamber 6, and providing the gas deflection member 12 spaced apart from the additional gas deflection member 25, as illustrated in FIGS. 13 to 15. The purpose of the additional gas deflection member 25 is to additionally promote even distribution of reaction gas in the reaction gas chamber 6 prior reaction gas exiting the reaction gas chamber 6 via the annular opening 7 and entering the reaction shaft 1 of the suspension smelting furnace 2. In FIG. 13, an additional gas deflection member 25 that is in the form of a tubular member provided with a plurality of through openings 13 leading through the tubular member and that surrounds the feeder pipe 4 is provided. In FIG. 14, an additional gas deflection member 25 that is in the form of a tubular member and that surrounds the feeder pipe 4 is provided. In FIG. 15, an additional gas deflection member 25 that is in the form of an annular disc and that surrounds the feeder pipe 4 is provided and that is fastened to the feeder pipe 4.

The method comprises preferably, but not necessarily, providing the burner 3 with a dispersing device 22, which is concentrically arranged inside the feeder pipe 4 and which extend out from an orifice 23 of the feeder pipe 4 for directing dispersing gas to the solid material that is fed from the orifice 23 of the feeder pipe 4, and directing dispersing gas to the solid material that is fed from the orifice 23 of the feeder pipe 4 to cause deflection of said solid material towards the reaction gas that is fed from the annular opening 7.

Next the burner 3 for feeding solid material and reaction gas into a reaction shaft 1 of a suspension smelting furnace 2 and some embodiments and variants of the burner 3 will be presented in greater detail.

The reaction gas can for example comprise air, oxygen-enriched air, and/or oxygen.

The solid material can for example comprise sulphidic concentrate, flux, slag former, and/or electronic scrap.

The suspension smelting furnace 2 can be a flash smelting or a flash converting furnace. The suspension smelting furnace 2 comprises additionally a settler (not marked with a reference numeral) configured to receive material from the reaction shaft 1 and an uptake (no marked with a reference numeral) for leading process gases from the settler.

The burner 3 can be a concentrate or a matte burner.

The burner 3 comprises a feeder pipe 4 for feeding solid material into the reaction shaft 1 of the suspension smelting furnace 2.

The burner 3 comprises a gas supply device 5 for feeding reaction gas into the reaction shaft 1 of the suspension smelting furnace 2.

The gas supply device 5 comprises a reaction gas chamber 6, which surrounds, preferably concentrically surrounds, the feeder pipe 4.

The gas supply device 5 opens to the reaction shaft 1 of the suspension smelting furnace 2 through an annular opening 7.

The reaction gas chamber 6 is at least partly laterally outwardly limited by an inner wall section 8 tapering, preferably conically tapering, towards the annular opening 7 and is at least partly limited by a top structure 9.

The gas supply device 5 comprises at least one inlet channel 10 opening into the reaction gas chamber 6 device for feeding reaction gas into the reaction gas chamber 6 through a feed opening 11 of said at least one inlet channel 10.

The burner 3 comprises a gas deflection member 12 in the reaction gas chamber 6. The gas deflection member 12 limiting at least one through opening 13 leading through the gas deflection member 12.

The gas deflection member 12 is preferably, but not necessarily, stationary such as nonrotatable arranged with respect to the reaction gas chamber 6.

Said feed opening 11 of said at least one inlet channel 10 is configured to direct reaction gas towards the inner wall section 8 tapering towards the annular opening 7 and/or configured to direct reaction gas towards the gas deflection member 12. Said feed opening 11 of said at least one inlet channel 10 is preferably, but not necessarily, as in the embodiments illustrated in FIGS. 2 to 8 and 11, configured to direct reaction gas between the top structure 9 and the gas deflection member 12 towards the inner wall section 8 tapering towards the annular opening 7 and/or configured to direct reaction gas towards the gas deflection member 12. Towards the gas deflection member 12 means in this context that reaction gas is not directed solely towards one through opening 13 leading through the gas deflection member 12, but at least partly towards material forming the gas deflection member 12 so as to at least partly avoid that reaction gas flows directly out of the reaction gas chamber 6 from the annular opening 7. The purpose of the gas deflection member 12 is to divert the direction of the reaction gas and so to even out the flow of reaction gas within the reaction gas chamber 6 so that the flow of reaction gas from the annular opening 7 into the reaction shaft 1 of the suspension smelting furnace 2 will be more evenly distributed, which promotes reactions between reaction gas and solid material in the reaction shaft 1 of the suspension smelting furnace, which in turn leads to a higher metal recovery from the solid material that is fed into the reaction shaft 1 of the suspension smelting furnace 2. The gas deflection member 12 will also even out possible differences in flow velocity of the reaction gas flowing from the annular opening 7 at different locations of the annular opening 7.

Said at least one inlet channel 10 penetrates in some embodiments and variants of the burner 3, such as illustrated in FIGS. 2 to 7 and 11, into the reaction gas chamber 6 so that said at least one inlet channel 10 have a channel section 14 inside the reaction gas chamber 6 and so that said feed opening 11 of said at least one inlet channel 10 is inside the reaction gas chamber 6. Said at least one inlet channel 10 passes preferably, but not necessarily, through the top structure 9 of the reaction gas chamber 6, as illustrated in FIGS. 2 to 7 and 11. Said channel section 14 is preferably, but not necessarily, bent and/or angled away from the central axis A of the burner 3 to direct reaction gas from the feed opening 11 between the top structure 9 and the gas deflection member 12 towards the inner wall section 8 tapering towards the annular opening 7, as illustrated in FIGS. 2 to 7 and 11.

Some variants and embodiments of the burner 3 can, as illustrated in FIGS. 2 to 7 and 11, comprise a plurality of inlet channels 10 passing through the top structure 9 in a configuration symmetrical to a central axis A of the burner 3 so that each of said plurality of inlet channels 10 having a channel section 14 inside the reaction gas chamber 6 and so that each said channel section 14 is bent and/or angled away from the central axis A of the burner 3 to direct reaction gas from the feed opening 11 towards the inner wall section 8 tapering towards the annular opening 7 between the top structure 9 and the gas deflection member 12, and so that the feed openings 11 of the inlet channels 10 are arranged in a configuration symmetrical to a central axis A of the burner 3.

It is also possible that the feed opening 11 of said at least one inlet channel 10 is arranged at the top structure 9, as illustrated in FIGS. 8 and 10.

It is also possible that the feed opening 11 of said at least one inlet channel 10 is arranged at the inner wall section 8 partly limiting the reaction gas chamber 6, as illustrated in FIGS. 12 to 15.

The gas deflection member 12 comprises preferably, but not necessarily, as illustrated in FIGS. 2 to 15, a surrounding structure 15 that surrounds the feeder pipe 4.

If the gas deflection member 12 comprise a surrounding structure 15, the surrounding structure 15 of the gas deflection member 12 can, as illustrated in FIG. 12, comprises a tubular member provided with a plurality of through openings 13 leading through the wall of the gas deflection member 12 in the form of a tubular member. The tubular member is preferably, but not necessarily, dimensioned and designed so that the annular opening 7 is visible from the top structure 9 so that for example a camera can be provided at the top structure 9 so as to enable monitoring of the smelting process in the reaction shaft 1 of the suspension smelting furnace by means of a camera can be provided at the top structure 9 through the annular opening 7.

If the gas deflection member 12 comprise a surrounding structure 15, the surrounding structure 15 of the gas deflection member 12 can, as illustrated in FIGS. 2 to 8, 10, 11, and 13 to 15, be at the inner wall section 8 tapering towards the annular opening 7.

The surrounding structure 15 can, as illustrated in FIGS. 2 to 8, 10, 11, and 13 to 15, comprise an annular disc 21 comprising an inner circumference 19 and an outer circumference 20. The outer circumference 20 of the annular disc 21 can be attached to the inner wall section 8 tapering towards the annular opening 7 as illustrated in FIGS. 2 to 8, 10, 11, and 13 to 15. The annular disc 21 can have at least one disc discontinuity point 26. The annular disc 21 can be formed of a plurality of arc sections 24 spaced from one another in the circumferential direction of the first ring member. Such arc sections 24 are preferably, but not necessarily, symmetrically provided so as to at least partly promote for a symmetrical flow of reaction gas from the annular opening 7. The annular disc 21 has preferably, but not necessarily, an essentially flat and planar configuration.

If the gas deflection member 12 comprises a surrounding structure 15 that surrounds the feeder pipe 4 and if the surrounding structure 15 comprises an annular disc 21 comprising an inner circumference 19 and an outer circumference 20, the gas deflection member 12 can, as illustrated in FIGS. 2 to 6, 11, and 13 to 15, comprise one through opening 13 that is formed by a central through opening that is limited by the inner circumference 19 of the annular disc 21 of the surrounding structure. The central through opening is preferably, but not necessarily, dimensioned and designed so that the annular opening 7 is visible from the top structure 9 so that for example a camera can be provided at the top structure 9 so as to enable monitoring of the smelting process in the reaction shaft 1 of the suspension smelting furnace by means of a camera can be provided at the top structure 9 through the annular opening 7.

If the gas deflection member 12 comprises a surrounding structure 15 that surrounds the feeder pipe 4 and if the surrounding structure 15 comprises an annular disc 21 comprising an inner circumference 19 and an outer circumference 20, a rim member 16 can, as illustrated in FIGS. 4 to 7, be provided at the annular disc 21. The purpose of the rim member 16 is to deflect the flow of reaction gas in the reaction gas chamber 6 so as to promote even distribution of reaction gas in the reaction gas chamber 6 and so as to even out possible differences in flow velocity of the reaction gas prior reaction gas exiting the reaction gas chamber 6 through the annular opening 7 and enters the reaction shaft 1 of the suspension smelting furnace. The rim member 16 can, as illustrated in FIG. 4, have at least one rim discontinuity point 17. The rim member 16 can, as illustrated in FIG. 4, comprise plurality of rim sections 18 spaced from one another in the circumferential direction of the annular disc 21. Such rim sections 18 are preferably, but not necessarily, symmetrically provided so as to at least partly promote for a symmetrical flow of reaction gas from the annular opening 7.

The rim member 16 is preferably, but not necessarily, provided at the inner circumference 19 of the annular disc 21 as illustrated in FIGS. 4 to 7.

If the gas deflection member 12 comprises a surrounding structure 15 that surrounds the feeder pipe 4 and if the surrounding structure 15 comprises an annular disc 21 comprising an inner circumference 19 and an outer circumference 20, the burner 3 can, as illustrated in FIG. 4, comprise two inlet channels 10 each having one feed opening 11 so that the feed openings 11 are provided diametrically with respect to the feeder pipe 4 on opposite sides of the feeder pipe 4, and the rim member 16 can comprise two rim sections 18 provided diametrically at the annular disc 21 so that one rim section 18 is provided axially below one of the inlet channels 10 and so that the other rim section 18 is provided axially below the other of the inlet channels 10.

If the gas deflection member 12 comprises a surrounding structure 15 that surrounds the feeder pipe 4 and if the surrounding structure 15 comprises an annular disc 21 comprising an inner circumference 19 and an outer circumference 20, the outer circumference 20 of the annular disc 21 can be attached to the inner wall section 8 tapering towards the annular opening 7 and the inner circumference 19 of the annular disc 21 can be attached to the feeder pipe 4 for feeding solid material into the reaction shaft 1 of the suspension smelting furnace 2, and the annular disc can be provided with a plurality of through openings 13, as illustrated in FIG. 8.

If the gas deflection member 12 comprises a surrounding structure 15 that surrounds the feeder pipe 4 and if the surrounding structure 15 comprises an annular disc 21 comprising an inner circumference 19 and an outer circumference 20, the outer circumference 20 of the annular disc 21 can be attached to the inner wall section 8 tapering towards the annular opening 7 and the annular disc 21 can be provided with a plurality of through openings 13, as illustrated in FIG. 10.

The burner 3 can in addition to the gas deflection member 12 be provided with an additional gas deflection member 25 in the reaction gas chamber 6 so that the gas deflection member 12 is provided spaced apart from the additional gas deflection member 25 as illustrated in FIGS. 13 to 15. The purpose of the additional gas deflection member 25 is to additionally promote even distribution of reaction gas in the reaction gas chamber 6 prior reaction gas exiting the reaction gas chamber 6 via the annular opening 7. In FIG. 13, the additional gas deflection member 25 is in the form of a tubular member provided with a plurality of through openings 13 leading through the tubular member and that surrounds the feeder pipe 4. In FIG. 14, the additional gas deflection member 25 is in the form of a tubular member and that surrounds the feeder pipe 4. In FIG. 15, the additional gas deflection member 25 is in the form of an annular disc and that surrounds the feeder pipe 4 and that is fastened to the feeder pipe 4.

The burner 3 can comprise a dispersing device 22, which is concentrically arranged inside the feeder pipe 4 and which extend out from an orifice 23 of the feeder pipe 4 for directing dispersing gas to the solid material that is fed from the orifice 23 of the feeder pipe 4.

It is apparent to a person skilled in the art that as technology advanced, the basic idea of the invention can be implemented in various ways. The invention and its embodiments are therefore not restricted to the above examples, but they may vary within the scope of the claims.

1.-42. (canceled)

43. A method for evening out the feeding of reaction gas when feeding solid material and reaction gas into a reaction shaft of a suspension smelting furnace by means of a burner, the method comprising:
feeding solid material into the reaction shaft of the suspension smelting furnace by means of a feeder pipe of the burner, and
feeding reaction gas into the reaction shaft of the suspension smelting furnace by means of a gas supply device of the burner, wherein the gas supply device comprises a reaction gas chamber, which surrounds the feeder pipe, wherein the gas supply device opens to the reaction shaft of the suspension smelting furnace through an annular opening, wherein the reaction gas chamber being at least partly laterally outwardly limited by an inner wall section tapering towards the annular opening, and by a top structure,
feeding reaction gas into the reaction gas chamber through a feed opening of at least one inlet channel of the gas supply device,
providing a gas deflection member in the reaction gas chamber, wherein the gas deflection member limiting at least one through opening leading through the gas deflection member, and
directing reaction gas from said feed opening of said at least one inlet channel of the gas supply device towards the inner wall section tapering towards the annular opening and/or towards the gas deflection member.

44. The method according to claim 43, wherein the method further comprises:
arranging said at least one inlet channel of the gas supply device to penetrate into the reaction gas chamber so that said at least one inlet channel having a channel section inside the reaction gas chamber and so that said feed opening of said at least one inlet channel is inside the reaction gas chamber.

45. The method according to claim 44, wherein the method further comprises:
arranging said at least one inlet channel of the gas supply device to pass through the top structure of the reaction gas chamber.

46. The method according to claim 44, wherein the method further comprises:
arranging said channel section bent and/or angled away from a central axis A of the burner to direct reaction gas from the feed opening towards the inner wall section tapering towards the annular opening between the top structure and the gas deflection member.

47. The method according to claim 43, wherein the method further comprises:
arranging a plurality of inlet channels of the gas supply device to pass through the top structure in a configuration symmetrical to a central axis A of the burner so that each of said plurality of inlet channels having a channel section inside the reaction gas chamber,
arranging each channel section bent and/or angled away from the central axis A of the burner to direct reaction gas from the feed opening towards the inner wall section tapering towards the annular opening between the top structure and the gas deflection member, and
arranging the feed openings of the inlet channels in a configuration symmetrical to a central axis A of the burner.

48. The method according to claim 43, wherein the method further comprises:
the gas deflection member that is provided comprises a surrounding structure that is arranged to surround the feeder pipe.

49. The method according to claim 48, wherein the method further comprises:
providing the surrounding structure of the gas deflection member at the inner wall section tapering towards the annular opening.

50. The method according to claim 49, wherein the method further comprises:
the surrounding structure of the gas deflection member that is provided comprises an annular disc comprising an inner circumference and an outer circumference.

51. A burner for feeding solid material and reaction gas into a reaction shaft of a suspension smelting furnace, wherein the burner comprises:
a feeder pipe for feeding solid material into the reaction shaft of the suspension smelting furnace,
a gas supply device for feeding reaction gas into the reaction shaft of the suspension smelting furnace, wherein the gas supply device comprises a reaction gas chamber, which surrounds the feeder pipe, wherein the gas supply device opens to the reaction shaft of the suspension smelting furnace through an annular opening, wherein the reaction gas chamber being at least partly laterally outwardly limited by an inner wall section tapering towards the annular opening and by a top structure, and wherein the gas supply device comprises at least one inlet channel opening into the reaction gas chamber device for feeding reaction gas into the reaction gas chamber through a feed opening of said at least one inlet channel, and
a gas deflection member in the reaction gas chamber, wherein the gas deflection member limiting at least one through opening leading through the gas deflection member, and wherein
said feed opening of said at least one inlet channel being configured to direct reaction gas towards the inner wall section tapering towards the annular opening and/or configured to direct reaction gas towards the gas deflection member.

52. The burner according to claim 51, wherein
said at least one inlet channel penetrates into the reaction gas chamber so that said at least one inlet channel has a channel section inside the reaction gas chamber and so that said feed opening of said at least one inlet channel is inside the reaction gas chamber.

53. The burner according to claim 52, wherein
said at least one inlet channel passes through the top structure of the reaction gas chamber.

54. The burner according to claim 52, wherein
said channel section is bent and/or angled away from the central axis A of the burner to direct reaction gas from the feed opening towards the inner wall section tapering towards the annular opening between the top structure and the gas deflection member.

55. The burner according to claim 51, further comprising:
a plurality of inlet channels passing through the top structure in a configuration symmetrical to a central axis A of the burner so that each of said plurality of inlet channels having a channel section inside the reaction gas chamber, wherein
each said channel section being bent and/or angled away from the central axis A of the burner to direct reaction gas from the feed opening towards the inner wall section tapering towards the annular opening between the top structure and the gas deflection member, and
the feed openings of the inlet channels being arranged in a configuration symmetrical to a central axis A of the burner.

56. The burner according to claim 51, wherein
the gas deflection member comprises a surrounding structure that surrounds the feeder pipe.

57. The burner according to claim 56, wherein
the surrounding structure of the gas deflection member being at the inner wall section tapering towards the annular opening.

58. The burner according to claim 57, wherein
The surrounding structure comprises an annular disc comprising an inner circumference and an outer circumference.
